(19) United States
(12) Patent Application Publication
(10) Pub. No.: US 2024/0268413 A1
(43) Pub. Date: Aug. 15, 2024

(54) EGG REPLACEMENT COMPOSITIONS

(71) Applicant: ZERO EGG LTD., Kfar Saba (IL)

(72) Inventors: Liron Nimrodi, Neve Yarak (IL); Samuel Bernhardt, Rehovot (IL); Yael Hanoch, Modiin (IL)

(21) Appl. No.: 18/567,235

(22) PCT Filed: Jun. 20, 2022
(86) PCT No.: PCT/IL2022/050661

§ 371 Date: Dec. 5, 2023

Related U.S. Application Data
(60) Provisional application No. 63/213,213, filed on Jun. 22, 2021.

(30) Foreign Application Priority Data
Jun. 21, 2021 (IL) 284261

(51) Int. Cl. A23J 3/16; A21D 2/16; A21D 2/26; A23D 9/04; A23L 5/44; A23L 15/00; A23L 27/00

(52) U.S. Cl. CPC A23J 3/16; A21D 2/165; A21D 2/266; A23D 9/04; A23L 5/44; A23L 15/35; A23L 27/84

(57) ABSTRACT

The present invention provides egg replacement compositions comprising at least 14 wt% of protein(s) from a vegetable source, sodium chloride, natural vegetable oil and water, wherein the composition comprises less than 4% of hydrocolloids or polycarbohydrates. The present invention further provides food products comprising the egg replacement composition. The food products of the present invention have organoleptic properties similar to those of a natural egg.

### FIELD OF THE INVENTION

The present invention relates to egg replacement compositions comprising at least 10 wt % of protein(s) from a vegetable source, sodium chloride, natural vegetable oil and water, wherein the composition comprises less than 4% of hydrocolloids or polycarbohydrates. The composition of the present invention when prepared has organoleptic properties similar to that of a natural egg.

### BACKGROUND OF THE INVENTION

Eggs are one of the most widely consumed food products in the world. Eggs are a great source of protein, vitamins, iron amount other nutrients. In addition to their great nutritional value, eggs are also widely used and one of the essential ingredients in a variety of culinary applications, including savory and sweet baking and cooking. Eggs are useful in culinary since they provide a wide range of culinary properties, such as leavening, thickening, binding, coagulating, emulsifying and moisturizing.

Many attempts have been made to create an egg substitute that replaces the desired nutritional and culinary features of natural eggs. Some examples are mashed bananas and/or applesauce to replace eggs in baking, baking powder/baking soda mixtures to provide leavening, flour/water mixtures to provide binding and leavening. The drawback of such substitutes is that they provide only a single property of eggs in cooking. Most, if not all, egg supplements comprise water retaining compounds such as hydrocolloids or polycarbohydrates to preserve the texture of the compositions upon preparation.

Even though some egg replacers are commercially available, there is still a need for a good egg replacement that can replace a whole egg in all its culinary and nutritional features without adding non-necessary caloric value.

### SUMMARY OF THE INVENTION

According to one aspect, the present invention provides an egg replacement

composition comprising at least 10 wt % or at least 14 wt % of protein or a combination of proteins from a vegetable source, from 0.01 to 1% of an edible salt, from 1 to 15% of a natural vegetable oil and water, wherein the composition comprises less than 3% of hydrocolloids or polycarbohydrates. According to some embodiments, the composition comprises from 14 to 25 wt % of the protein or the combination of proteins. According to some embodiments, the content of the amino acid cysteine (Cys) in the protein or in the combination of proteins is from about 0.9 to 4% of the protein or of the combination. According to some embodiments, the content of the amino acid cysteine (Cys) in the protein or in the combination of proteins is from about 1 to 4% of the protein or of the combination. According to some embodiments, the composition comprises a combination of proteins. Thus, according to some embodiments, the present invention provides an egg replacement composition comprising a combination of proteins each from a vegetable source, from 0.01 to 1% of an edible salt, from 1 to 15% of a natural vegetable oil and water, wherein the composition comprises least 10 wt % or at least 14 wt % of proteins and less than 3% of hydrocolloids and/or polycarbohydrates.

According to some embodiments, the combination of proteins comprises from 60 to 90 wt % of a high-Cys protein comprising e.g. from 1 to 3 wt % of Cys. According to some embodiments, the combination of proteins comprises from 10 to 40 wt % of a low-Cys protein comprising e.g. up to 1 wt % of Cys. According to some embodiments, the high-Cys-protein is (i) a soy protein isolate, (ii) a rice protein or rice protein isolate, (iii) or a combination of (i) and (ii). According to some embodiments, the low-Cys protein is a protein from Fabaceae. According to some embodiments, the protein from Fabaceae is selected from pea protein, chickpea protein, mung bean protein and any combination thereof. According to some embodiments, the high-Cys-protein is a soy protein isolate and the low-Cys protein is pea protein.

According to some embodiments, the egg replacement composition of the present invention comprises from 10 to 40% of soy protein isolate, from 1 to 15% of protein from Fabaceae, from 0.01 to 1% sodium chloride, from 1 to 15% of a natural vegetable oil and water, wherein the composition comprises at least 14 wt % of proteins and less than 1% of hydrocolloids.

According to some embodiments, the composition comprises from 2 to 10% of protein from Fabaceae.

According to some embodiments, the composition comprises from 10 to 20% of soy protein isolate.

According to some embodiments, the composition comprises from 0.05 to 0.5% edible salt.

According to some embodiments, the edible salt is sodium chloride.

According to some embodiments, the composition comprises from 2 to 25%, from 2 to 15 or from 2 to 12 of a vegetable oil. According to some embodiments, the vegetable oil has neutral flavor. According to some embodiments, the vegetable oil is a natural vegetable oil or a derivative thereof. According to some embodiments, the vegetable oil is selected from sunflower, safflower oil, cottonseed oil, canola oil and a combination thereof. According to some embodiments, the composition comprises less than 0.1% of the hydrocolloids or polycarbohydrates.

According to some embodiments, the egg replacement composition is substantially devoid of hydrocolloids. According to some embodiments, the egg replacement composition is substantially devoid of polycarbohydrates.

According to some embodiments, the egg replacement composition further comprises a food colorant such as a turmeric coloring, beta carotene or a combination thereof. According to some embodiments, the composition comprises from 0.005 to 0.5% of the food colorant.

According to some embodiments, the egg replacement composition further comprises one or more taste maskers. According to some embodiments, the composition comprises from 0.005 to 0.5% of the taste maskers.

According to some embodiments, the egg replacement composition of the present invention further comprises an additional vegetable protein. According to some embodiments, the additional vegetable protein is selected from potato, pumpkin hemp protein, protein from any other vegetable source and any combination thereof.

According to some embodiments, the egg replacement composition of the present invention comprises from 10 to 20 wt % of soy protein isolate, from 1 to 10 wt % of pea protein, from 0.05 to 0.3 wt % of sodium chloride, from 0.005 to 0.03 wt % of Turmeric coloring, from 0.005 to 0.03 wt % of beta carotene, from 0.01 to 0.5 wt % of taste masker, from 1 to 10 wt % of oil and water to complete to 100%, wherein the composition comprises at least 14 wt % of proteins. According to some embodiments, the content of the amino acid cysteine (Cys) in the protein or in the combination of proteins is from about 0.9 to 4% of the protein or of the combination.

According to any one of the above embodiments, the egg replacement composition further comprises edible fiber, e.g. from 0.05 to 2 wt % of the edible fibers.

According to some embodiments, the egg replacement composition of the present invention is in a form selected from a powder, paste or dough.

According to any one of the above embodiments, the pH of the egg replacement composition is from about 3 to about 12.

According to another aspect, the present invention provides a food product comprising or prepared from the egg replacement composition of the present invention. According to some embodiments, the food product is a product that typically includes an egg. According to some embodiments, the egg replacement food product is prepared from a mixture of the content of the egg replacement composition of the present invention. According to some embodiments, the egg replacement food product is prepared from a mixture of at least 14 wt % of a protein or a combination of proteins from a vegetable source, from 0.01 to 1% of an edible salt, from 1 to 25% of a natural vegetable oil and optionally water, wherein the food product comprises less than 3% of hydrocolloids wherein the content of the amino acid cysteine (Cys) in the protein or in the combination of proteins is from about 0.9 to about 4% or about 1 to about 4% of the protein or of the combination. According to some embodiments, the food product comprises less than 3% of hydrocolloids. According to some embodiments, the food product is substantially devoid of hydrocolloids. According to some embodiments, the egg replacement food product is prepared by mixing the content of the egg replacement composition as described herein.

According to some embodiments, the food product is selected from a patty, scramble, egg bite, omelet, and bakery goods. According to some embodiments, the egg replacement composition may be pre-treated before cooking. According to some embodiments, the food product of the present invention has one or more organoleptic properties similar to food products comprising eggs, wherein the organoleptic property is selected from texture, taste, and flavor.

### DETAILED DESCRIPTION OF THE INVENTION

Typically, egg replacement compositions use a high content of hydrocolloids or carbohydrates in order to preserve the structure, texture and palatability of products prepared from these compositions, such as omelets, patties, egg bites or scrambled eggs. Such compositions further require the use of a large amount of flavors to mask the taste. Addition of hydrocolloids or polycarbohydrates is generally undesired due to their high caloric value, on one hand, and the fact that some of these compounds are considered to be non-natural, highly processed or nutritionally detrimental on the other hand.

The present invention is based on an observation that it is possible to obtain high-quality egg replacement compositions by choosing a well-defined content of carefully selected proteins, salt and oils without using hydrocolloids or polycarbohydrates as stabilizers. Such egg replacement compositions allow the preparation of food products having palatability properties similar to those of eggs. The resulting food products received very high scores in independent tests and were comparable to products comprising natural eggs in taste when consumed in the normal fashion. Moreover, these products were better than the commercially available products in that they had no cholesterol, had high protein content and were low in calories. These products are also environmentally friendly and suitable for any vegan diet. In addition, food products obtained from the compositions of the present invention preserve the initial “egg like” spongy texture, presumably due to the protein matrix structure, are not subject to the conformational changes normally associated with hydrocolloids or gums over time or when the product temperature changes (cools or is reheated) and mimics eggs in that they have significantly reduced weight loss during cooking as a result of the higher water retention and substantially lower evaporation of water during heating. In addition, the products of the present invention lack enzymes typically used in food processing such as trans-glutaminase. It was further observed that the table salt softens the composition. It was shown that without the salt the resulted food product is stiffer, harder and sturdier than with salt.

According to some aspects, the present invention provides an egg replacement composition comprising at least 10 wt % of protein(s) from a vegetable source, from 0.01 to 2% of edible salt, from 1 to 15% of a natural vegetable oil and water, wherein the composition comprises less than 4% of hydrocolloids and/or polycarbohydrates. According to some embodiments, the egg replacement composition comprises at least 12 wt % or at least 14 wt % of protein(s) from a vegetable source. Thus, according to one aspect, the present invention provides an egg replacement composition comprising at least 14 wt % of protein(s) from a vegetable source, from 0.01 to 1% of edible salt, from 1 to 15% of a natural vegetable oil, and water, wherein the composition comprises less than 4 wt % of hydrocolloids or polycarbohydrates. According to some embodiments, the composition comprises less than 3.5 wt %, less than 3 wt %, less than 2.5 wt % less than 2 wt %, less than 1.5 wt %, less than 1 wt % or less than 0.5 wt % hydrocolloids, polycarbohydrates or both hydrocolloids and polycarbohydrates. According to some embodiments, the egg replacement composition is substantially devoid of hydrocolloids and polycarbohydrates as structure stabilizers.

According to some embodiments, the egg replacement composition is substantially devoid of hydrocolloids and polycarbohydrates. According to some embodiments, the egg replacement composition is devoid of hydrocolloids and polycarbohydrates. The term “less than X% of hydrocolloids” has the meaning of the range from X to 0 including zero. Thus the term encompass the condition in which no hydrocolloids are present.

One additional advantage of the composition of the present invention is that the concentration of proteins is higher than in eggs typically comprising 6-13% of protein. The term “protein” is used herein to include molecules or molecular complexes having an amino acid sequence of sufficient chain length to produce a secondary structure and includes single polypeptide chains or protein complexes comprising two or more polypeptides. The term encompasses single type proteins as well as a plurality of different proteins. Thus, the term “protein” and “proteins” and “combination of proteins” may be used interchangeably in some embodiments.

The term “edible salt”, as used herein, refers to a salt that is generally considered suitable for human consumption, particularly a non-toxic salt. Acceptable salts include base addition salts and acid addition salts of the corresponding free acid. Metallic salts include alkali metal salts, such as sodium and potassium salts, alkaline earth metal salts, such as calcium and magnesium salts. Organic salts include salts made from secondary, tertiary and quaternary amines such as diethylamine, triethylamine, ethanolamine, diethanolamine, and salts made from cationic amino acids such as arginine, lysine and histidine. Examples of suitable acid addition salts include hydrochloride, phosphate, hydrogen phosphate, acetate, aspartate, ascorbate, citrate, gluconate, lactate, succinate, tartrate, etc. According to some embodiments, the edible salt is sodium chloride. According to other embodiments, the edible salt is potassium chloride. According to one embodiment, the edible salt is calcium chloride.

According to some embodiments, the composition comprises a combination of edible salts. According to some embodiments, the composition comprises from 0.01 to 0.6 wt %, from 0.05 to 0.5 wt %, from 0.07 to 0.45, from 0.08 to 0.3 wt % from 0.1 to 0.3wt %,from 0.1 to 0.2 wt % or about 0.15 wt % of the edible salt such as sodium chloride.

According to some embodiments, the present invention provides an egg replacement composition comprising at least 14 wt % of protein(s) from a vegetable source, from 0.01 to 1% of sodium chloride, from 1 to 15 wt % of a natural vegetable oil and water, wherein the composition comprises less than 4% of hydrocolloids or polycarbohydrates. According to some embodiments, the egg replacement composition comprises at least 15 wt % or at least 16 wt % or at least 18 wt % of protein or a combination of proteins. According to some embodiments, the egg replacement composition of the present invention comprises from about 14 to about 25 wt % of protein or a combination of proteins. According to some embodiments, the present invention comprises from about 14 to about 20 or from about 15 to about 18 wt % of the protein or the combination of proteins.

According to some embodiments, the content of the amino acid cysteine (Cys) in the protein or in the combination of proteins is from about 0.9 to about 4% of the protein or of the combination of proteins. According to some embodiments, the content of the amino acid cysteine (Cys) in the protein or in the combination of proteins is from about 1 to about 4% of the protein or of the combination of proteins. According to some embodiments, the content of the amino acid cysteine (Cys) in the protein or in the combination of proteins is from about 1 to about 4% of the protein or of the combination of proteins. According to some embodiments, the content of Cys in the protein(s) is from about 1.5 to about 3.5, from about 2 to about 3%. According to some embodiments, the content of Cys in the protein(s) is from about 2 to about 2.5%. According to some embodiments, the content of Cys in the protein(s) is from about 0.9 to about 1.5% or from 0.9 to 1.2%.

According to some embodiments, the egg replacement composition comprises a combination of proteins. According to one embodiment, the content of Cys amino acids in the combination of proteins comprises from about 0.9 to about 4%, from about 1 to about 4% from about 1.5% to about 3.5%, or from about 2% to about 3%. According to some embodiments, the content of Cys amino acids in the combination of proteins is from about 2 to about 2.5%. According to some embodiments, the content of Cys amino acids in the combination of proteins is from about 0.9 to about 1.2%.

According to some embodiments, the combination of proteins comprises from about 60 to about 90% of high-Cys proteins. The term “high-Cys protein” refers to proteins having a high content of cysteine, i.e. 1% or more. The term “low-Cys protein” refers to proteins comprising less than 1% cysteine. According to some embodiment, the high-Cys protein comprises from 1 to about 3% Cys. According to some embodiments, the high-Cys protein comprises from about 1.5 to about 2.5% or from about 1.7 to about 2.3% of Cys amino acids. According to some embodiments, the high-Cys protein comprises from about 2 to about 3% Cys amino acids or from about 2.5 to about 3% of Cys amino acids or from about 2.7% of Cys amino acids. According to some embodiments, the high-Cys protein comprises from about 1 to about 2% or from about 1 to about 1.5% of Cys amino acids. According to some embodiment, the low-Cys protein comprises from 0.01 to 0.99% Cys amino acids.

According to some embodiment, the low-Cys protein comprises from 0.3 to below 0.8% of Cys amino acids. According to some embodiment, the low-Cys protein comprises from 0.4 to below 0.8% of Cys amino acids or about 0.7% of cysteines. The term “% of cysteine in protein” refers to the percent of the weight of cysteine amino acid out of the weight of dry protein, i.e. wt %.

According to some embodiments, the combination of proteins comprises from about 65 to about 85%, from about 70 to about 80% of high-Cys protein(s).

According to some embodiments, the high-Cys protein is a soy protein isolate. According to some embodiments, the combination of proteins comprises from 60 to 90%, from about 65 to about 85%, from about 70 to about 80% of a soy protein isolate. The term “soy protein” refers to proteins derived from whole soybeans which contain no non-soy derived additives. Such additives may, of course, be added to a soy protein to provide further functionality or nutrient content in an extruded meat analog containing the soy material. The term “soybean” refers to the species Glycine max, Glycine soja, or any species that is sexually cross-compatible with Glycine max. The term “soy protein isolate” as used herein is used in the sense conventional to the soy protein industry. Specifically, a soy protein isolate is a soy material having a protein content of at least 90% soy protein on a moisture-free basis. “Isolated soy protein”, as used in the art, has the same meaning as “soy protein isolate” as used herein and as used in the art. In some embodiments, the terms “soy protein” and “soy protein isolate” may be used interchangeably. The term “soy protein” also refers collectively to a mixture of two more soy proteins derived from soy beans. For example, a “soy protein” may be a mixture of soy proteins. According to some embodiments, the high-Cys-protein(s) is selected from a soy protein isolate, rice protein and a combination thereof.

According to some embodiments, the soy protein isolate comprises from 80 to 99 wt % of soy protein. According to some embodiments, the soy protein isolate comprises from 85 to 95 wt % of soy protein or 90% or more of soy protein.

According to some embodiments, the high-Cys protein is rice protein. According to some embodiments, the high-Cys protein is rice protein isolate.

According to some embodiments, the combination of proteins comprises from about 10 to about 40%, from about 20 to about 30% or about 25% of low-Cys protein(s).According to any one of the above embodiments, the combination of protein comprises from about 10 to about 40 wt % of a low-Cys protein comprising up to 1% of Cys. According to some embodiment, the combination of protein comprises from about 15 to about 35 wt %, or from about 20 to 30 wt % of a low-Cys protein. According to some embodiments, the low-Cys protein comprises from about 0.1 to about 0.95% of Cys or from about 0.2 to about 0.7% of Cys. According to some embodiments, the low-Cys protein comprises from about 0.6 to about 0.95% of Cys.

According to some embodiments, the low-Cys protein is a protein from Fabaccac. Thus, according to some embodiments, the combination of proteins comprises from about 10 to about 40 wt % of the protein from Fabaceae. According to some embodiments, the combination of protein comprises from about 15 to about 35 wt %, or from about 20 to 30 wt % of the protein from Fabaceae. According to some embodiments, the protein from Fabaceae is selected from pea protein, chickpea protein, mung bean protein and a combination thereof. According to some embodiments, the protein from Fabaceae is pea protein. According to some embodiments, the composition comprises from about 10 to about 40 wt %, from about 15 to about 35 wt %, or from about 20 to 30 wt % of pca protein.

As it is used herein, the term “Fabaceae” or “Leguminosas” refers to a family of plants, commonly known as the legume family, pea family or bean family. In the present invention, the term “pea protein” is the generic name given to any protein isolate obtained from yellow pea, Pisum sativum, seeds. “Pea protein” contains Legumin, which has some similar properties to Casein, and pea protein products are promoted as an alternative to whey protein. “Pea protein” is worldwide sold under different trademarks such as, Nutralys®, and P80X, among others and it can also be prepared from pea cultivars by well-known routine methods, such as alkali extraction/isoelectric precipitation (AE-IP), salt extraction-dialysis (SE), and micellar precipitation (MP), among others.

Proteins found in peas are typically comprised of three classes of proteins: globulins, albumins and insoluble proteins. In a typical pea protein composition, the soluble proteins of the pea, i.e. the globulins (legumins, vicilins and concivilins) and albumins (predominantly the albumins PA1 and PA2) comprise about 85% of the total proteins. For the purpose of the present specification, the term “pea protein” may refer to any one or more of these individual, or groups of, proteins found in peas, more typically to a “pea protein” composition. Typically the “pea protein” used is a pea protein combination or composition, in the form of a pea protein isolate, pea protein lysate, pea protein hydrolysate, pea protein concentrate or coagulated pea protein composition. The terms “pea protein”, “pea protein composition”, “pea protein isolate” and “pea protein combination” may be used interchangeably herein. In an exemplary embodiment, the pea protein is extracted or derived from yellow peas. According to some embodiments, the term “pea protein” refers to pea protein composition/isolate comprising at least 80 wt % of protein.

According to some embodiments, the combination of proteins comprises from about 65 to about 85%, from about 70 to about 80% of high-Cys protein(s) and from about 10 to about 40%, from about 20 to about 30% or about 25% of low-Cys protein(s). The high-Cys and low-Cys proteins are as described above.

According to any one of the embodiments, the egg replacement composition comprises a vegetable oil. According to some embodiments, the vegetable oil has neutral flavor. According to some embodiments, the vegetable oil is a natural vegetable oil. According to other embodiments, the vegetable oil is a derivative of natural oil. According to some embodiments, the vegetable oils are selected from the group consisting of coconut oil, palm oil, palmist oil, soy oil, rapeseed oil, sunflower oil, cottonseed oil, canola oil, castor oil, corn oil, flaxseed oil, safflower oil, olive oil, avocado oil, soybean oil and sesame oil. According to some embodiments, the oil is selected from sunflower, safflower oil, cottonseed oil, and canola oil. According to some embodiments, the composition comprises from 2 to 10 wt %, from 3 to 7 wt %, from 10 to 20 wt %, from 12 to 18 wt %, or from 13 to 17 wt % of the vegetable oil. According to some embodiments, the egg replacement composition comprises from 1 to 20 wt % of the oil. According to some embodiments, the egg replacement composition comprises from 4 to 15 wt % of the oil. According to other embodiments, the egg replacement composition comprises. According to some embodiments, the egg replacement composition comprises from 1 to 12 wt %, from 2 to 10 wt % from 3 to 7 wt % or about 5 wt % of the oil. According to some embodiments, the egg replacement composition comprises from 2 to 12 wt % of the vegetable oil.

According to some embodiments, the present invention provides an egg replacement composition comprising from 10 to 40% of soy protein isolate, from 1 to 15% of protein from Fabaceae, from 0.01 to 1% edible salt, from 1 to 15% of a natural vegetable oil and water, wherein the composition comprises at least 10 wt % or at least 12 wt % of proteins and less than 3% of hydrocolloids or polycarbohydrates. According to some embodiments, the egg replacement composition comprises from 14 to 25 wt % of the proteins. According to some embodiments, the present invention provides an egg replacement composition comprising from 10 to 40% of soy protein isolate, from 1 to 15% of protein from Fabaceae, from 0.01 to 1% edible salt, from 1 to 15% of a natural vegetable oil and water, wherein the composition comprises at least 10 wt % of proteins and less than 3% of hydrocolloids or polycarbohydrates. According to one embodiment, the edible salt is sodium chloride. According to some embodiments, the egg replacement composition comprises less than 1% of hydrocolloids and polycarbohydrates. According to some embodiments, the egg replacement composition is substantially devoid of hydrocolloids and polycarbohydrates as structure stabilizers. According to some embodiments, the egg replacement composition is substantially devoid of hydrocolloids and polycarbohydrates. According to some embodiments, the composition comprises from 2 to 10% of protein from Fabaccac. According to some embodiments, the protein from Fabaceae is selected from pea protein, chickpea protein, mung bean protein and a combination thereof. According to some embodiments, the composition comprises from 10 to 20% of soy protein isolate. According to some embodiments, the composition comprises from 12 to 18 wt % of soy protein isolate. According to some embodiments, the comprises from 2 to 25 wt % of the vegetable oil. According to some embodiments, the composition comprises from 2 to 10 wt %, from 3 to 7 wt %, from 10 to 20 wt %, from 12 to 18 wt %, or from 13 to 17 wt % of the vegetable oil. According to some embodiments, the vegetable oil has a neutral flavor. According to some embodiments, the vegetable oil is selected from safflower oil, cottonseed oil, and canola oil. According to some embodiments, the vegetable oil is a natural oil or a derivative thereof. The term “comprises” encompasses also the term “consisting of” and may be replaced by it.

According to some embodiments, the present invention provides an egg replacement composition comprising from 10 to 40% of rice protein, from 1 to 15% of protein from Fabaceae, from 0.01 to 1% sodium chloride, from 1 to 15% of a natural vegetable oil and water, wherein the composition comprises at least 14 wt % of proteins and less than 3% of hydrocolloids or polycarbohydrates. According to some embodiments, the egg replacement composition comprises from 14 to 25 wt % of the proteins. According to some embodiments, the egg replacement composition comprises less than 1% of hydrocolloids or polycarbohydrates. According to some embodiments, the egg replacement composition is substantially devoid of hydrocolloids and polycarbohydrates as structure stabilizers. According to some embodiments, the egg replacement composition is substantially devoid of hydrocolloids and polycarbohydrates. According to some embodiments, the composition comprises from 2 to 10% of protein from Fabaceae. According to some embodiments, the protein from Fabaceae is selected from pea protein, chickpea protein, mung bean protein and a combination thereof. According to some embodiments, the composition comprises from 10 to 20% of rice protein. According to some embodiments, the composition comprises from 12 to 18 wt % of rice protein. According to some embodiments, the comprises from 2 to 25 wt % of the vegetable oil. According to some embodiments, the composition comprises from 2 to 10 wt %, from 3 to 7 wt %, from 10 to 20 wt %, from 12 to 18 wt %, or from 13 to 17 wt % of the vegetable oil. According to some embodiments, the vegetable oil has a neutral flavor. According to some embodiments, the vegetable oil is selected from safflower oil, cottonseed oil, and canola oil. According to some embodiments, the vegetable oil is a natural oil or a derivative thereof. According to some embodiments, the composition further comprises cysteine amino acid. According to some embodiments, the content of Cys in the composition is from 1 to 4 wt % of the protein content. The term “comprises” encompasses also the term “consisting of” and may be replaced by it.

According to some embodiments, the content of cysteine amino acids in the egg replacement composition is from 0.1 to 1 wt %. According to some embodiments, the content of cysteine amino acids in the egg replacement composition is from 0.1 to 0.8 wt %, from about 0.2 to about 0.6 or about 0.4 wt % of the egg replacement composition. According to some embodiments, the cysteine amino acids are amino acids of the protein or protein combination.

According to any one of the above embodiments, the composition comprises from 0.05 to 0.5 wt % of sodium chloride. According to some embodiments, the composition comprises from 0.07 to 0.4 wt %, from 0.1 to 0.3 wt % or from 0.1 to 0.2 wt % of sodium chloride. As shown in the Examples, the amount of salt may influence the physical properties of the product.

According to some embodiments, the egg replacement composition comprises less than 1 wt % of hydrocolloids. According to some embodiments, the egg replacement composition comprises less than 1 wt % of polycarbohydrates. According to some embodiments, the egg replacement composition comprises less than 1 wt % of hydrocolloids and polycarbohydrates, collectively. According to some embodiments, the composition comprises less than 0.8 wt %, less than 0.6 wt %, less than 0.5 wt %, less than 0.3 wt % or less than 0.1 wt % of hydrocolloids and polycarbohydrates, collectively. Typically hydrocolloids and/or polycarbohydrates are used in egg replacement composition as stabilizers of a structure. According to some embodiments, the egg replacement composition of the present invention is substantially devoid of such hydrocolloids and polycarbohydrates. According to some embodiments, the egg replacement composition is substantially devoid of hydrocolloids and polycarbohydrates as stabilizers. According to some embodiments, the egg replacement composition is substantially devoid of hydrocolloids and polycarbohydrates. According to some embodiments, the egg replacement composition is devoid of hydrocolloids and polycarbohydrates. The terms “substantially devoid”, “essentially devoid”, “devoid”, “does not include” and “does not comprise” may be used interchangeably and refer to composition that does not include, contain or comprise a particular component, e.g. said composition comprises less than 0.1 wt %, less than 0.01 wt %, or less than 0.001 wt % of the component. In some embodiments, the term devoid contemplates a composition comprising traces of the devoid component such as traces of a component used in the purification process. The content of the hydrocolloids in the composition may be tested by any known method.

As used herein, the term “hydrocolloid” refers to a broad class of water-soluble or water-dispersible polymers having anionic, cationic, zwitterionic or non-ionic character that forms a gel with water and as used herein has its usual and customary meaning which specifically includes dietary fiber compounds that form gel. According to some embodiments, the hydrocolloids encompass also polycarbohydrates, such as starch, modified starch, dextrin, maltodextrin, and cellulose derivatives, and their quaternized forms; natural gums such as alginate esters, carrageenan, xanthanes, agar-agar, pectins, pectic acid, and natural gums such as gum arabic, gum tragacanth and gum karaya, guar gums and quaternized guar gums; gellan, konjac, gelatin, protein hydrolysates and their quaternized forms; synthetic polymers and copolymers, such as poly(vinyl pyrrolidone-co-vinyl acetate), poly(vinyl alcohol-co-vinyl acetate), poly((met)acrylic acid), poly(maleic acid), poly(alkyl(meth)acrylate-co-(meth)acrylic acid), poly(acrylic acid-co-maleic acid)copolymer, poly(alkyleneoxide), poly(vinylmethylether), poly(vinylether-co-maleic anhydride), and the like, as well as poly-(ethyleneimine), poly((meth)acrylamide), poly(alkyleneoxide-co-dimethylsiloxane), poly(amino dimethylsiloxane), and the like, and their quarternized forms. Thus, according to some embodiments, the term hydrocolloids encompass also the term polycarbohydrates.

The term “carbohydrate” and “saccharides are used herein interchangeably and refer to a group that includes sugars, starch, and cellulose. The saccharides are divided into four chemical groups: monosaccharides, disaccharides, oligosaccharides, and polysaccharides. The terms “polysaccharides” and “polycarbohydrates” are used herein interchangeably and refer to long carbohydrates and typically capable of forming a colloids. According to some embodiment, the composition is substantially devoid of the hydrocolloids/polycarbohydrates listed above, e.g. as a stabilizer of the structure.

According to any one of the above embodiments, the egg replacement composition further comprises a food coloring. The terms “food coloring agent”, “food coloring” and “food colorant” as used herein refers to an agent that affects the color of food and may be e.g. as defined by the US Food and Drug Administration. According to some embodiments, the composition comprises from 0.001 wt % to 0.1 wt %, from 0.005 wt % to 0.08 wt % or from 0.01 wt % to 0.06 wt % of the food colorant. According to some embodiments, the food colorant provides a yellowing color of the egg. According to some embodiments, the food colorant is selected from Turmeric coloring, beta carotene or a combination thereof. According to some embodiments, the composition comprises from 0.005 wt % to 0.03 wt % of Turmeric coloring and from 0.005 wt % to 0.03 wt % of beta carotene.

According to any one of the above embodiments, the egg replacement comprises a taste masker. According to some embodiments, the composition comprises from 0.005 to 0.5% of the taste masker. According to some embodiments, the composition comprises from 0.01 wt % to 0.4 wt %, from 0.05 wt % to 0.3 wt % or from 0.075 wt % to 0.25 wt % of the taste masker.

The term “taste” refers to those sensations perceived through the stimulation of receptor cells or channels located in the taste buds or within the epithelium of the tongue, oral cavity and throat. While there are five tastes termed as “basic tastes”- sweet, sour salty, bitter and umami, there are others less well known. Within the flavor profile foodstuffs there is a variety of taste and odors perceived and interpreted by the brain in what we call “taste”. Many plant based products have distinct and uneven (not well rounded) flavor profiles which leave, for instance, intense bitter, sour or astringent sensations. One method of “masking” such flavors is to use molecules which block the transduction pathway of the taste sensation (blocking receptors for example), another is to use a flavor which appears exactly where the offending flavor does in the flavor profile, thereby “masking” the offending flavor or creating an intense flavor which camouflages the offending taste sensation, yet another is “taste suppression” or “mixture suppression”, where use of a metered combination of other flavors is perceived as less intense. According to some embodiments, the taste masker is a masker of bitter taste.

According to any one of the above embodiments, the egg replacement composition comprises fibers. In some embodiments, the fiber is dietary fiber. According to such embodiments, the fibers such as dietary fibers do not form gel upon hydration. It is to be emphasized that the dietary fibers used in the compositions of the present invention do not form colloids in water.

In some embodiments, the fiber comprises cellulose, inulin, or both. In some embodiments, the dietary fiber is cellulose fiber. In some embodiments, the dietary fiber is inulin. In some embodiments, the dietary fiber is cellulose fiber and inulin. In some embodiments, the egg replacement composition as described herein comprises 0.01 wt % to 5 wt % (w/w) fibers, from 0.05 to 2 wt %, from 0.1 wt % to 1.5 wt % or from 0.2 to 0.6 wt % of fibers. In some embodiments, the egg replacement composition comprises from 6 wt % to 12 wt %, from 8 wt % to 12 wt % or about 10 wt % of fibers, such as dietary fibers. In some embodiments, the fiber is bran, e.g., a wheat bran, oat bran, corn bran, rice bran, or other bran. In some embodiments, the bran can be micronized into a fine powder. According to some embodiments, the fibers, such as dietary fibers , are used for adjusting the color of the end product. According to some embodiment, the adjusting comprises lightening the color of the food product.

As used herein, the term “fiber” refers to non-starch carbohydrates in the form of polysaccharide. Fiber can be soluble in water or insoluble in water. Many microalgac produce both soluble and insoluble fiber, typically residing in the cell wall. As used herein, the term “dietary fiber” refers to non-starch carbohydrates found in plants and other organisms containing cell walls, including microalgae. Dietary fiber can be soluble (dissolved in water) or insoluble (not able to be dissolved in water). Soluble and insoluble fiber makes up total dietary fiber.

According to any one of the above embodiments, the egg replacement further comprises an additional vegetable protein. According to some embodiments, the additional vegetable protein is selected from potato, pumpkin, hemp protein and any combination thereof. According to some embodiments, the composition comprises from 0.0001% to 1% of the additional vegetable protein. According to some embodiments, the composition comprises from 0.0001% to 0.01%, from 0.0005 to 0.005 wt % or from 0.0005 to 0.003 wt % or from 0.00075 to 0.002 wt %, or about 0.001 wt % of the additional vegetable protein.

According to some embodiments, the present invention provides an egg replacement composition comprising from 10 to 20% of soy protein isolate, from 1 to 10% of pea protein, from 0.05 to 0.3% of sodium chloride, from 0.005 to 0.03% of Turmeric coloring, from 0.005 to 0.03% of beta carotene, from 0.01 to 0.5% of taste masker, from 1 to 10% or from 10 to 20% of oil, and water to complete to 100%, wherein the composition comprises at least 14 wt % of protein. According to some embodiments, the composition is substantially devoid of hydrocolloids.

According to any one of the above embodiments, the water completes the composition to 100 wt %. According to any one of the above embodiments, the amount of water is added depending on the desired viscosity and the type of the egg replacement composition.

According to any one of the above embodiments, the composition further comprises an edible excipient. The term “excipient” encompasses all solvents, dispersion media, preservatives, antioxidants, coatings, isotonic and absorption delaying agents, surfactants, fillers, disintegrants, binders, diluents, lubricants, glidants, pH adjusting agents, buffering agents, enhancers, wetting agents, solubilizing agents, surfactants, antioxidants the like, that are compatible with food. According to some embodiments, the egg replacement composition comprises a compound selected from cysteine, cystine, methionine. According to some embodiments, the high-Cys protein may be substituted with a low-Cys protein with the addition of cysteine amino acids. According to some embodiments, the overall content of cysteine in the egg replacement composition is from about 0.9 to 4 wt % or from about 1 to 4 wt % of the protein content.

According to any one of the above embodiments, all components of the composition of the present invention are natural products.

According to any one of the above embodiments, the egg replacement composition

of the present invention has pH of from about 3 to about 12. According to some embodiments, the pH of the composition is from about 4 to about 11, from about 5 to about 10, from about 6 to about 9, from about 7 to about 8, or from about 6 to about 8. According to some embodiments, the pH is maintained using a pH modifying agent.

According to any one of the above embodiments, the composition comprises aggregates of proteins. According to some embodiments, Dv(10) of the combination is from about 50 μm to about 90 μm or from about 60 μm to about 80 μm or about 65-75 μm or about 70 μm. According to some embodiments, Dv(50) is from about 150 μm to about 200 μm or from about 160 μm to about 190 μm, or from about 170-180 μm or about 175 μm. According to some embodiments, the Dv(90) is from about 300 μm to about 370 μm from about 320 μm to about 350 μm, or from 330-340 μm or about 335 μm. According to some embodiments, the Dv(10) of the combination is from about 60 μm to about 80 μm, the Dv(50) is from 160 μm to 190 um and the Dv(90) is from about 320 μm to about 350 μm. The term “D90” or Dv(90) as used herein refers to the size value corresponding to cumulative size distribution at 90%, which represents the size of particles below which 90% of the sample lies. In other words, 90% of the particles in the sample have a size smaller than the value set in D90. Similarly, the terms Dv(10) and Dv(50) represent values below which 10% or 50% of particles lie. According to some embodiments, the particle size is measured at t=0, without hydration. Any method for measurement may be used. A non-limiting example is DLS.

According to any one of the above embodiments, the egg replacement composition is in a form selected from a powder, paste or dough. According to some embodiments, the egg replacement composition is in a form selected from a powder.

According to some embodiments, the egg replacement composition of the present invention has one or more organoleptic properties similar to that of an egg and at least one functional property similar or equivalent to a corresponding functional property of an egg. According to some embodiments, the at least one functional property comprises emulsification, water binding capacity, foaming, gelation, crumb density, structure-forming, texture building, cohesion, adhesion, elasticity, springiness, solubility, viscosity, fat absorption, flavor binding, coagulation, leavening, acration, creaminess, film-forming property, sheen addition, shine addition, frecze stability, thaw stability, or color.

According to some embodiments, the egg replacement composition exhibits a gelation onset temperature above 75° C. According to some embodiments, the egg replacement composition exhibits a gelation onset temperature of from 75° C. to 100° C., from 80 to 95° C. or from 85 to 95° C.

According to another aspect, the present invention provides a food product comprising the egg replacement composition of the present invention. According to some embodiments, the present invention provides a food product comprising the content of the egg replacement composition of the present invention. All above aspects, embodiments and definitions apply herein as well. According to some embodiments, the food product comprises an egg replacement composition comprising at least 14 wt % of a protein(s) from a vegetable source, from 0.01 to 1% edible salt such as sodium chloride, from 1 to 25% of a natural vegetable oil and water, wherein the composition comprises less than 4% of hydrocolloids or polycarbohydrates. According to some embodiments, the food product is prepared from a mixture of at least 14 wt % of a protein(s) from a vegetable source, from 0.01 to 1% edible salt such as sodium chloride, from 1 to 15% of a natural vegetable oil and water, wherein the composition comprises less than 4% of hydrocolloids or polycarbohydrates. According to some embodiments, the food product is prepared from the egg replacement composition of the present invention.

According to some embodiments, the food product comprises at least 14 wt % of a protein(s) from a vegetable source, from 0.01 to 1% edible salt such as sodium chloride, from 1 to 25% of a natural vegetable oil and water, wherein the composition comprises less than 4% of hydrocolloids or polycarbohydrates. According to some embodiments, the content of the amino acid cysteine (Cys) in the protein or in the combination of proteins is from about 0.9 to 4% of the protein or of the combination

According to some embodiments, the food product comprises less than 3.5wt %, less than 3wt %, less than 2.5 wt % less than 2wt %, less than 1.5wt %, less than 1 wt % or less than 0.5 wt % hydrocolloids, polycarbohydrates or both hydrocolloids and polycarbohydrates. According to some embodiments, the food product is substantially devoid of hydrocolloids and polycarbohydrates as structure stabilizers. According to some embodiments, the food product is substantially devoid of hydrocolloids and polycarbohydrates.

According to some embodiments, the food product is prepared by a method comprising mixing the content of the egg replacement composition according to any one of the above embodiments and aspects. According to some embodiments, the food product further comprises thermal processing.

According to some embodiments, the food product of the present invention is selected from a patty, scramble, egg bite, omelet and bakery goods. According to some embodiments, the food prepared from the egg replacement composition of the present invention has at least one organoleptic property similar to the food product prepared from egg, e.g. same texture, flavor and taste. According to some embodiments, the food product is prepared from the egg replacement composition of the present invention. According to another embodiment, the food product comprises the egg replacement composition of the present invention.

According to some embodiments, the food product is cooked/prepared by any known preparation method. The term “cooking” may refer to the practice of preparing a food product for consumption from a food component with the use of heat. The term “cooking” may for instance refer to roasting, baking, boiling, frying, smoking, etc. Specific examples are e.g. grilling, broiling, flash baking, blanching, poaching, pressure cooking, steaming, deep frying, steam bath, etc. According to some embodiments, the food product is prepared by frying, cooking, boiling, baking or any other conventional methods of the composition of the present invention. According to some embodiments, the food product is prepared using any known devices like sous vide, oven, frying pan and so on. According to some embodiments, the food product is an egg-like product. According to some embodiments, the food product is selected from a patty, scramble, egg bite, and omelet. According to some embodiments, the food product obtained from the composition of the present invention is selected from meringue, crepes, omelet, frittata and egg bites. According to some embodiments, the food product comprising the egg replacement composition of the present invention comprises any food product that traditionally comprises egg. Non-limiting examples of such food products are noodles, pasta, ice cream, salad dressing, vegetable spreads, protein shakes and quiche. Other examples are baked products such as cakes, muffins, cookies, biscotti, pancakes, brownies, bread, scones, tarts, pies, pastries, waffles, pizza crust, profiterole, glaze, pie crust, and biscuits.

According to some embodiments, the food product loses less than 15% or less than 12% of the weight upon heating for 10 min or less at a temperature of 110° C. or less.

According to some embodiments, the food product loses less than 10%, less than 6%, less than 5%, less than 4%, less than 3% in its dimensions upon heating for 10 min or less at a temperature of 110° C. or less. The term “dimension” refers to each of the 3 dimensions as well to all dimensions collectively.

According to some embodiments, the present invention provides food products such as bakery products comprising an egg replacement composition comprising at least 10 wt % of a protein(s) from a vegetable source, from 0.01 to 1% edible salt such as sodium chloride, from 1 to 15% of a natural vegetable oil and water, wherein the composition comprises less than 4% of hydrocolloids. According to some embodiments, the present invention provides food products such as bakery products comprising a content of mixture of at least 10 wt % of a protein(s) from a vegetable source, from 0.01 to 1% edible salt such as sodium chloride, from 1 to 15% of a natural vegetable oil and water, wherein the food products comprise less than 4% of hydrocolloids.

The food product of the present invention is an egg replacement food product.

According to some embodiments, the composition of the present invention is pretreated before final cooking. According to some embodiments, the pretreatment is selected from high-shear, sonication, heat treatment or a combination thereof. The pretreatment of the composition may affect certain properties such as a solubility, turbidity, particle size, particle size distribution, free sulfhydryl groups content, surface hydrophobicity, viscosity, water holding capacity, oil capacity, and emulation stability. As such, the pretreatment may provide a uniform particle size distribution, higher free sulfhydryl groups content, more elevated surface hydrophobicity, higher viscosity, water holding capacity, oil capacity, or emulation stability. Upon pretreatment, the pretreated composition of the present invention may further be cooked to obtain the final product.

The compositions of the present invention allow the preparation of designed food. The composition of the present invention allow preparing different form and shapes and subsequently designing the food as desired.

The terms “a,” “an,” and “the” ” are used herein interchangeably and mean one or more.

The term “and/or” is used to indicate one or both stated cases may occur, for example, A and/or B includes, (A and B) and (A or B).

The term “or,” as used herein, denotes alternatives that may, where appropriate, bc combined; that is, the term “or” includes each listed alternative separately as well as their combination if the combination is not mutually exclusive.

The terms “comprising”, “comprise(s)”, “include(s)”, “having”, “has” and “contain(s),” are used herein interchangeably and have the meaning of “consisting at least in part of”. When interpreting each statement in this specification that includes the term “comprising”, features other than that or those prefaced by the term may also be present. Related terms such as “comprise” and “comprises” are to be interpreted in the same manner. The terms “have”, “has”, having” and “comprising” may also encompass the meaning of “consisting of” and “consisting essentially of”, and may be substituted by these terms. The term “consisting of” excludes any component, step or procedure not specifically delineated or listed. The term “consisting essentially of” means that the composition or component may include additional ingredients, but only if the additional ingredients do not materially alter the basic and novel characteristics of the claimed compositions or methods.

As used herein, the term “about”, when referring to a measurable value such as an amount, a temporal duration, and the like, is meant to encompass variations of +/−10%, or +/−5%, +/−1%, or even +/−0.1% from the specified value.

The invention will now be illustrated by the following non-limiting Examples.

Having now generally described the invention, the same will be more readily understood through reference to the following examples, which are provided by way of illustration and are not intended to be limiting of the present invention.

### EXAMPLES

### Example 1. Egg Replacement Formulations.

Recognizing that no single protein displayed the desired characteristics to effectively mimic hens' eggs, we discovered that certain proteins whose structure are high in α-helix and low in β-pleated sheets (as measured using Circular dichroism) were closest to hens' eggs texture upon cooking.

While displaying some of the desired characteristics, the best examples of these proteins were typically too “hard” when cooked, creating a “bite” which was unpleasant in comparison to hens' eggs. This was also the case when these proteins had high ratios of cysteine, encouraging inter molecular bonding.

Other proteins were too “soft” also creating a significant drift from the target hens' egg “bite”.

Typically, these deltas are compensated for by adding hydrocolloids, surfactants, emulsifiers etc.

While neither of these protein types displayed a marked change in the level of α-helix or β-pleated sheets presented before and after heating, we discovered a difference in the creation of protein aggregates or complexes.

We discovered that the proteins having a “hard” bite upon cooking displayed a marked reduction in smaller aggregates with a minor change to the larger aggregates, indicating the combination of the smaller aggregates into larger aggregates accompanied by a moderate increase in total protein surface area.

Some of the proteins which were “softer” displayed a relatively even reduction in aggregate sizes upon mixing, indicating some combined aggregates but also a significant reduction in larger aggregates all told, creating less of an organized structure.

We have prepared several mixtures of proteins (with additional components) as described in Formulations I-II.

Formulation I (NSP)

| Ingredient | % of product |
|---|---|
| Water | 74.718% |
| Soy protein | 15.000% |
| Pea protein | 5.000% |
| Chickpea protein | 0.001% |
| Potato protein | 0.001% |
| Salt | 0.150% |
| Turmeric coloring | 0.015% |
| Beta carotene | 0.015% |
| Masker soy | 0.100% |
| Oil | 5.000% |
| Overall | 100.000% |

Formulation II

| | % of product | | |
|---|---|---|---|
| | Formulation IIa | Formulation II b | Formulation II c |
| Ingredient | (5% oil) | (15% oil) | (10% oil) |
| Water | 74.72% | 64.72% | 69.72% |
| Soy protein | 15.000% | 15.000% | 10.000% |
| Pea protein | 5.000% | 5.000% | 5.000% |
| NaCl | 0.150% | 0.150% | 0.150% |
| Turmeric | 0.015% | 0.015% | 0.015% |
| coloring | | | |
| Beta carotene | 0.015% | 0.015% | 0.015% |
| Taste Masker | 0.100% | 0.100% | 0.100% |
| Oil | 5.000% | 15.000% | 10.000% |
| Overall | 100.000% | 100.000% | 100.000% |

We defined soy protein as a “hard” protein and pea protein as a “soft protein”.

We have analyzed the relative change in aggregation for each protein, and their mixtures using laser diffraction to measure the particle size and particle size distribution of materials, or DLS before and hydration for 5 min. The results are summarized in Table 1.

By combining proteins from both groups together in the right ratio (highly favoring the hard “bite” family), we were able to change the aggregation of the combined protein mix to mimic that of the “soft” bite protein, resulting in a “bite” close and highly favoring the hens' egg “bite” after cooking.

The resulting protein mix retained the high ratio of α-helix to β-pleated in the protein mix after hydration and mixing. The mixture of proteins displayed aggregation behavior closer to that of the of the soft “bite” family, while retaining the Span or size distribution (Dv(90)-DV(10)/DV(50)) similar to that of the hard “bite” proteins accompanied by a higher increase in total protein surface area as a result of the resulting structure or matrix created.

It is possible to lower the amount of water to obtain a more viscous egg replacement composition.

TABLE 1

| | Soy Protein | | Pea Protein | | NSP | |
|---|---|---|---|---|---|---|
| | (micron) | | (micron) | | (micron) | |
| | t = 0 | T = 5 min | t = 0 | T = 5 min | t = 0 | T = 5 min |
| Dv(10) | 81.1 | 56.2 | 44.8 | 32.2 | 70.9 | 45.7 |
| Dv(50) | 197 | 157 | 147 | 109 | 175 | 117 |
| Dv(90) | 350 | 321 | 325 | 252 | 336 | 253 |

Dv(X) represents a value in microns, X% of particles having the size of Dv(X) or less.

Interestingly, despite the prevalence of “hard” proteins (having high Cys content) in the mix of proteins, the combined mix has the aggregation characteristics of the “soft” protein.

### Example 2. Effect of Salt Amount on the Formulations' Properties.

We have tested effect of different components of the formulation on its properties. One of the tested factors was the amount of salt. We prepared the composition as defined in Formulation I and varied the amount of salt from 0% to 1%. We further prepared scramble from these composition and compared the properties of these products. The results are presented in Table 2.

TABLE 2

| | Scramble | Scramble 0.25% | Scramble 0.5% |
|---|---|---|---|
| Sample | no salt IC | salt IC | salt IC |
| Springiness | 4 | 4 | 3 |
| Chewiness | 3 | 3 | 3 |
| Softness | 6 | 7 | 8 |
| Dense | 5 | 5 | 5 |
| structure | | | |
| Overall score | 5 | 8 | 3 |
| (texture) | | | |
| comments | springy, needs | less springy than #1. | Too soft. Slightly |
| | to be a bit | No noticeable skin. | mushy. |
| | softer. | Good level of moisture | |

It can be seen that there is an optimum amount of salt that had to be discovered and could not have been predicted.

### Example 3. Comparison to Available Commercial Products

We compared petties and omelet prepared from the Formulation I of Example 1 and from the commercially available egg supplement produced by the company JUST (Scrambled JUST eggs).

### Preparation of Patty

55 gr of the final product (NSP or Scrambled JUST eggs) was baked in Oven for 10 min at 110° C. (with Teflon non-stick ring).

### Preparation of Omelet

55 gr of the final product as above was fried on a frying pan as follows:

130° C. for ZeroEgg (from 3 to 10 mins)

100° C. for Scrambled JUST eggs

The resulted food products were tested for weight loss (due to water evaporation) and change in dimensions by measuring the height. Considering that the products prepared from Just eggs were a priory very thin (about 0.3 cm), it was impossible to measure change in their dimensions.

The patties prepared from NSP have maintained their dimensions and lost about 2.7 wt % in their weight. Patties prepared from Scrambled Just eggs lost about 6.4 wt %.

Omelets prepared from NSP have maintained their dimensions and lost only about 10.3 wt % due to water evaporation whereas Omelets prepared from prepared from Scrambled Just eggs lost about 18.2 wt % due to evaporation.

The composition of the present invention showed to be more heat-stable and performed better than Just scramble egg to water holding capacity and maintaining geometric shape. This is especially evident for Omelet product. The composition of the present invention was prepared at higher temperature and lost about 2 times less in weight than the commercially available product. Moreover, as the disclosed composition maintains its form, it was possible to prepare a round omelet.

### Example 4. Survey

We performed a survey of a vegan sandwich with the egg petty of the present invention where the tasters were asked to compare the results of this patty to a “standard” breakfast sandwich which traditionally includes a hen's egg patty. The survey was performed among Flexitarians, vegans, vegetarians and other that are not included in the above groups. The following parameters were tested: overall score, taste, texture, color, purchase intent, etc., The results are summarized in the Table 3.

TABLE 3

| | Number | | | | Recom- | | | |
|---|---|---|---|---|---|---|---|---|
| | of | Enjoyed | | Compare | mend | | | Taste |
| | partici- | the | | to | to | How | Texture | of |
| Questions | pants | sandwich | Score | ″regular″ | Friend | often? | of Egg | Egg |
| SCALE | | liked a | 1 to 10 | Scale = 12 | 1 to 10 | Occa- | | |
| | | Lot = 10, | | Same = 7 | | sionally = | | |
| | | Loved = | | slightly | | 3 | | |
| | | 12 | | Better = | | Often = | | |
| | | | | 8-10 | | 5 | | |
| Flexitarian | 41 | 9.42 | 7.9 | 6.65 | 7.51 | 3.4 | 7.65 | 6.95 |
| None of | 32 | 9.53 | 7.84 | 6.5 | 7.47 | 3.4 | 7 | 6.9 |
| Above | | | | | | | | |
| Vegan | 8 | 10.8 | 8.88 | 10.38 | 9 | 3.75 | 7.75 | 7.25 |
| Vegetarian | 4 | 10.8 | 8.75 | 8.75 | 8.5 | 4 | 10 | 8.25 |
| Total | 85 | 9.7 | 8.1 | 7.05 | 7.7 | 3.48 | 7.54 | 7 |
| Comments | | Just under | | Just above | | Between | | |
| | | “Liked | | “Same as | | “Occa- | | |
| | | a | | Regular | | sionally” | | |
| | | Lot” | | Egg | | and | | |
| | | | | Sandwich” | | “Often” | | |

To summarize, the egg patty taste scored 7 (just above “same as a regular egg sandwich”) and the texture 7.5 on a 1-10 scale, with slightly higher scores given by the vegetarian (5%) and vegan (9%) taste.

### Example 5. Amino Acid Content of the Formulation

We tested the content of amino acids of the protein isolates used in the composition and the content of the amino acids in the composition. The results are present in Table 4

TABLE 4

| | | | NSP |
|---|---|---|---|
| | Soy protein | Pea | (gr amino acid/ |
| | isolate | Protein | 100 gr of the |
| | (gr amino acid/100 gr dry protein) | | composition |
| Arginine | 6.79 | 6.69 | 1.30 |
| Cystine | 2.71 | 0.68 | 0.40 |
| Tryptophan | 1.54 | 0.82 | 0.25 |
| Histidine | 2.76 | 1.99 | 0.49 |
| Tyrosine | 3.23 | 3.06 | 0.61 |
| Leucine | 7.71 | 6.92 | 1.43 |
| Glutamic acid | 16.93 | 13.24 | 3.04 |
| Glycine | 3.47 | 3.29 | 0.66 |
| Proline | 4.55 | 3.49 | 0.81 |
| Methionine | 1.29 | 0.84 | 0.22 |
| Serine | 4.66 | 4.20 | 0.87 |
| Lysine | 5.57 | 6.26 | 1.11 |
| Phenylalanine | 3.97 | 4.45 | 0.79 |
| Threonine | 2.95 | 3.03 | 0.57 |
| Valine | 4.16 | 4.26 | 0.80 |
| Aspartic acid | 10.57 | 9.51 | 1.97 |
| Alanine | 3.61 | 3.32 | 0.68 |
| Isoleucine | 3.55 | 3.97 | 0.70 |

### Example 6

The purpose of this experiment was to evaluate the consumer response to our patties prepared from the composition of the present invention as described in Formulation I in comparison to the market standard hens egg patties SYSCO in a standard breakfast sandwich.

As follows from the survey, no difference was found between the commercial hen's egg patty and that prepared from the egg replacement composition of Formulation I (ZE Patties).

Experimental set up.

The sandwiches included a toasted English muffin, aioli, patty, cheese and arugula. No sausage or other veg were added to allow consumers to focus on the patties themselves.

Consumers were pre recruited to taste a “breakfast sandwich” without any mention how the patties were prepared (with appropriate allergen warnings).

First, the sandwiches comprising patties prepared from the composition of the present invention were tested for overall score and for patty score. Sandwiches comprising patties from hen eggs were tested the next day. After tasting sandwiches comprising egg replacement-based patties, the participants were asked to score the sandwich and the patty again and asked to describe what they liked or disliked about the product.

The results are summarized in Tables 5 and 6.

TABLE 5

| | No | “Blind” Tasting | | |
|---|---|---|---|---|
| Questions | Participants | Like Sandwich | Patty Taste | Patty Texture |
| ZE Patty | 46 | 7.52 ± 1.74 | 7.44 ± 1.99 | 7.43 ± 2.3 |
| HE Patty | 47 | 7.59 ± 1.96 | 7.74 ± 2.10 | 7.93 ± 1.97 |

| | | | |
|---|---|---|---|
| Statistically Different? | NO | NO | NO |
| Scale | 1 to 10 | 1 to 10 | 1 to 10 |

TABLE 6

| | ″Surprise″—This | | | | Behavior | | |
|---|---|---|---|---|---|---|---|
| | is Plant Based | | | | | If Price right | How Much |
| | No | | | | Recom- | how often | More Pay |
| | Partici- | Like | Taste | Patty | mend | would you | for Plant |
| Questions | pants | Sandwich | Patty | Texture | to Friend | buy this | Based |
| ZE Patty | 46 | 6.59 ± | 7.57 ± | 7.37 ± | 4.17 ± 0.96 | 3.54 ± 1.05 | $1.57 ± 1.1 |
| | | 2.2 | 2.01 | 2.14 | | | |
| HE Patty | 47 | | | | 3.87 ± 1.17 | 3.45 ± 1.19 | $1.36 ± 0.88 |
| Statistically | | | | | p < 0.1 | NO | NO |
| Different? | | | | | | | |
| Scale | | 1 to 10 | 1 to 10 | 1 to 10 | 1 to 5 | 1 = Never, | |
| | | | | | | 2.5 = Occasionally, | |
| | | | | | | 5 = Often | |

To conclude, in a blind consumer tasting test, conducted by a 3^{rd} party, consumers could not differentiate between patties based on egg replacement composition of the present invention and the leading commercial hen's egg patty in a regular breakfast sandwich. Patties prepared from the egg replacement composition of the present invention received the same score as the leading commercial hen's egg patty for taste and texture. After the consumers were told that the ZE Patties were Plant Based, they scored the patty taste even higher than before. After the test, the consumers were more likely to recommend the sandwich with the Zero Egg Plant Based Patties to a friend than a similar sandwich with the leading commercial hen's egg patty. Even when we asked for negative comments or critique, 50% of the consumers had only positive things to say.

We asked separately whether the costumers liked and dislike the product. Ever after specifically asking for negative feedback, more that 50% of the customers had only positive feedback.

### Example 7. Compositions

Additional compositions comprising an alternative source of proteins were prepared as in Example 1. As known, different soy protein isolates may contain different protein fraction. The content of the protein mix used for the preparation of the egg replacement composition is presented in Table 7. The protein mix

TABLE 7
Protein mix for the egg replacement composition.

| | % in | % in | % | % Cys |
|---|---|---|---|---|
| | dough | powder | Prot | of Prot |
| Soy protein | 14.00% | 73.30% | 91 | 1.1 |
| isolate | | | | |
| Potato protein | 0.00% | 0.01% | | |
| Chickpea protein | 4.60% | 24.08% | 88 | 0.9 |
| Total Powder mix | 19.10% | 100.00% | | |

The content of cysteine amino acid in the protein mix is about 1%, more precisely above 1%.

The protein mix was further added to other components described in Example 1 formulations I and II) and further supplemented with cellulose fibers of about 0.5 wt % in the final composition.

Here and in Example 1, the amount of water may vary depending on the viscosity of the final product. The amount shown in Formulas I and II may be reduced to obtain an egg replacement composition in the form of dough.

Although the present invention has been described herein above by way of preferred embodiments thereof, it can be modified, without departing from the spirit and nature of the subject invention as defined in the appended claims

1-45. (canceled)

46. An egg replacement composition, comprising:
at least 14 weight % (wt %) of a protein or a combination of proteins from a vegetable source;
from 0.01 to 1 wt % of an edible salt;
from 1 to 15 wt % of a natural vegetable oil and water;
less than 3 wt % of hydrocolloids; and
wherein a content of an amino acid cysteine (Cys) in the protein or in the combination of proteins is from about 0.9 to 4% of the protein or of the combination.

47. The egg replacement composition according to claim 46, wherein the composition comprises from 14 to 25 wt % of the protein or the combination of proteins.

48. The egg replacement composition according to claim 46, further comprising a combination of proteins.

49. The egg replacement composition according to claim 48, wherein the combination comprises (i) from 60 to 90 wt % of a high-Cys protein(s) comprising from 1 to 3% of Cys amino acid, (ii) from 10 to 40 wt % of a low-Cys protein(s) comprising below 1% of Cys amino acid, or (iii) both (i) and (ii).

50. The egg replacement composition according to claim 49, wherein at least one of (i) the high-Cys-protein(s) is selected from the group consisting of a soy protein isolate, rice protein, and a combination thereof; or (ii) the low-Cys protein(s) is a protein from Fabaceae.

51. The egg replacement composition according to claim 50, wherein at least one of (i) the protein from Fabaceae is selected from the group consisting of pea protein, chickpea protein, mung bean protein, and a combination thereof; or (ii) high-Cys-protein is a soy protein isolate.

52. The egg replacement composition according to claim 46, further comprising from 10 to 40% of soy protein isolate, from 1 to 15% of protein from Fabaceae, from 0.01 to 1% sodium chloride, from 1 to 15% of a natural vegetable oil and water, wherein the composition comprises at least 14 wt % of proteins and less than 1% of hydrocolloids.

53. The egg replacement composition according to claim 52, wherein the (i) composition comprises from 2 to 10% of protein from Fabaceae, (ii) from 10 to 20% of soy protein isolate, or (iii) both (i) and (ii) .

54. The egg replacement composition according to claim 46, wherein at least one of:
(i) the composition comprises from 0.05 to 0.5% edible salt;
(ii) the composition comprises from 2 to 12% of a vegetable oil;
(iii) the composition comprises less than 0.1% of hydrocolloids;
(iv) the composition is substantially devoid of hydrocolloids;
(v) the composition further comprises a food colorant;
(vi) the composition further comprises a taste masker;
(vii) the composition further comprises an additional vegetable protein;
(viii) the composition further comprises edible fibers;
(ix) the composition is in a form selected from a powder, paste and dough;
(x) the pH of the composition is from about 3 to about 12; or (xi) wherein the composition exhibits a gelation onset temperature above 75° C.

55. The egg replacement composition according to claim 46, wherein at least one of:
(i) the vegetable oil is a natural vegetable oil or a derivative thereof;
(ii) the vegetable oil is selected from sunflower oil, safflower oil, cottonseed oil, canola oil and a combination thereof;
(iii) the food colorant is selected from Turmeric coloring, beta-carotene or a combination thereof;
(iv) the composition comprises from 0.005 wt % to 0.5 wt % of the food colorant;
(v) the additional vegetable protein is selected from potato, pumpkin, hemp protein and any combination thereof
(vi) the composition comprises from 0.0001 wt % to 1 wt % of the additional vegetable protein; or (vii) the edible fibers are cellulose fibers.

56. The egg replacement composition according to claim 46, wherein the composition comprises from 10 to 20 wt % of soy protein isolate, from 1 to 10 wt % of pea protein, from 0.05 to 0.3 wt % of sodium chloride, from 0.005 to 0.03 wt % of Turmeric coloring, from 0.005 to 0.03 wt % of beta carotene, from 0.01 to 0.5 wt % of taste masker, from 1 to 10 wt % of oil and water to complete to 100%, wherein the composition comprises at least 14 wt % of proteins.

57. The egg replacement composition according to claim 56, wherein the composition is substantially devoid of hydrocolloids.

58. The egg replacement composition according to claim 46, wherein the composition has one or more organoleptic properties similar to an egg and at least one functional property similar or equivalent to a corresponding functional property of an egg, wherein the at least one functional property comprises emulsification, water binding capacity, foaming, gelation, crumb density, structure forming, texture building, cohesion, adhesion, elasticity, springiness, solubility, viscosity, fat absorption, flavor binding, coagulation, leavening, aeration, creaminess, film forming property, sheen addition, shine addition, freeze stability, thaw stability, or color.

59. A food product, comprising:
the egg replacement composition or the content of the egg replacement composition according to claim 46 or prepared by mixing the content of the egg replacement composition according to claim 46.

60. The food product according to claim 59, wherein the food product comprises less than 3 wt % of hydrocolloids or substantially devoid of hydrocolloids.

61. The food product according to claim 59, wherein the food product is selected from the group consisting of a patty, scramble, egg bite, omelet, and bakery goods.

62. The food product according to claim 61, wherein the egg replacement composition is pre-treated before cooking.

63. The food product according to claim 59, having one or more organoleptic properties similar to a food product comprising eggs, wherein the organoleptic property is selected from at least one of texture, taste, or flavor.

64. A food product, comprising:
at least 14 wt % of a protein or a combination of proteins from a vegetable source;
from 0.01 to 1% of an edible salt, from 1 to 25% of a natural vegetable oil and optionally water;
less than 3% of hydrocolloids; and
wherein the content of the amino acid cysteine (Cys) in the protein or in the combination of proteins is from about 0.9 to 4% of the protein or of the combination.

65. The food product according to claim 64, wherein at least one of:
(i) the food product is substantially devoid of hydrocolloids;
(ii) the food product is selected from a patty, scramble, egg bite, omelet and bakery goods;
(iii) the egg replacement composition is pre-treated before cooking; or
(iv) the food product has one or more organoleptic properties similar to a food product comprising eggs, wherein the organoleptic property is selected from texture, taste, and flavor.
